(19) United States
(12) Patent Application Publication
(10) Pub. No.: US 2003/0140736 A1
(43) Pub. Date: Jul. 31, 2003

(54) Power tong positioning device

(76) Inventor: David A. Buck, Breaux Bridge, LA (US)

Correspondence Address: Lance A. Foster, Jones, Walker, Waechter, Poitevent,, Carrere & Denegre, L.L.P., 8555 United Plaza Boulevard, 4th Floor, Baton Rouge, LA, 70809-7000, US

(21) Appl. No.: 10/329,621

(22) Filed: Dec. 26, 2002

Related U.S. Application Data
(63) Continuation-in-part of application No. PCT/US01/41065, filed on Jun. 20, 2001.

(51) Int. Cl. B25B 13/50

(52) U.S. Cl. 81/57.35

(57) ABSTRACT

An improved power tong positioning device which includes a support arm and a base plate rotatably connected to the support aim. The device further includes a piston and cylinder assembly having a trunnion attached thereto and a trunnion bracket pivotally securing the piston and cylinder assembly to the base plate.

This application is a continuation-in-part of PCT Application PCT/US01/41065, filed Jun. 20, 2001 and claiming priority to U.S. application Ser. No. 09/603,754 filed on Jun. 26, 2000, both of which are incorporated by reference herein in their entirety.

### I. BACKGROUND OF INVENTION

The present invention relates to pipe tongs or power tongs used in the oil and gas industry to make-up and break-out sections of drill pipe and other tubular members with threaded connections. More particularly, the present invention relates to devices to assist in maintaining the pipe tongs in the proper position during their use.

Pipe tongs are often employed in the oil and gas industry to break-out or make-up threaded tubular member connections. It is generally required that one set of pipe tongs grip and rotate one section of a tubular string and a second set of pipe tongs grip and hold stationary the other section of the tubular string. The first tong rotating the first tubular member is typically referred to as the power tong, while the second tong holding the second tubular member stationary is typically referred to as the back-up power tong. Modern drilling operations usually employed powered pipe tongs, or power tongs. Examples of conventional power tongs can be seen in references such as U.S. Pat. Nos. 5,671,961, 5,819,604, and 5,702,139 to Buck, which are incorporated herein by reference.

Most often, when power tong assemblies (i.e., a power tong and backup tong combination) are placed into operation, they are suspended from cables as shown in FIG. 1. In some instances, such as when running larger diameter tubulars, a power tong may be used without aback-up power tong. When the power tong is suspended from a cable, to prevent rotation of the power tong and to hold the power tong in position horizontally, a cable is anchored onto the drilling rig itself and connected to the power tong.

Additionally, power tongs are bulky and heavy tools, with larger tongs weighing as much as 5,000 pounds or more and even smaller tongs weighing 1,500 to 1,800 pounds. Because of the size and bulk, three or more operators may be needed to position the power tong so that the tongs can grip the tubular members. Because the tongs are suspended from cables, they may swing freely and could potentially strike the nearby operators if not properly handled. To help reduce this danger, devices for positioning the power tong have been developed and may be referred to as “tong positioners.” Examples of tong positioners may be seen in U.S. Pat. Nos. 6,318,214 and 6,412,553, both of which are incorporated by reference herein in their entirety. However, there is still a need in the art for improved tong positioners.

### II. SUMMARY OF INVENTION

Therefore, the present invention provides an improved power tong positioning device which includes a support arm and a base plate rotatably connected to the support arm. The device further includes a piston and cylinder assembly having a trunnion attached thereto and a trunnion bracket pivotally securing the piston and cylinder assembly to the base plate.

### III. BRIEF DESCRIPTION OF DRAWINGS

FIG. 1 is perspective view of the tong positioning device of the present invention connected to a power tong assembly.

FIGS. 2a and 2b are detailed views of the base plate of the tong positioning device.

FIG. 3 is an exploded view of the piston and cylinder assembly and the trunnion brackets used in the present invention.

FIG. 4 is a schematic side view of the piston and cylinder assembly and base plate employed in the present invention.

### IV. DETAILED DESCRIPTION OF INVENTION

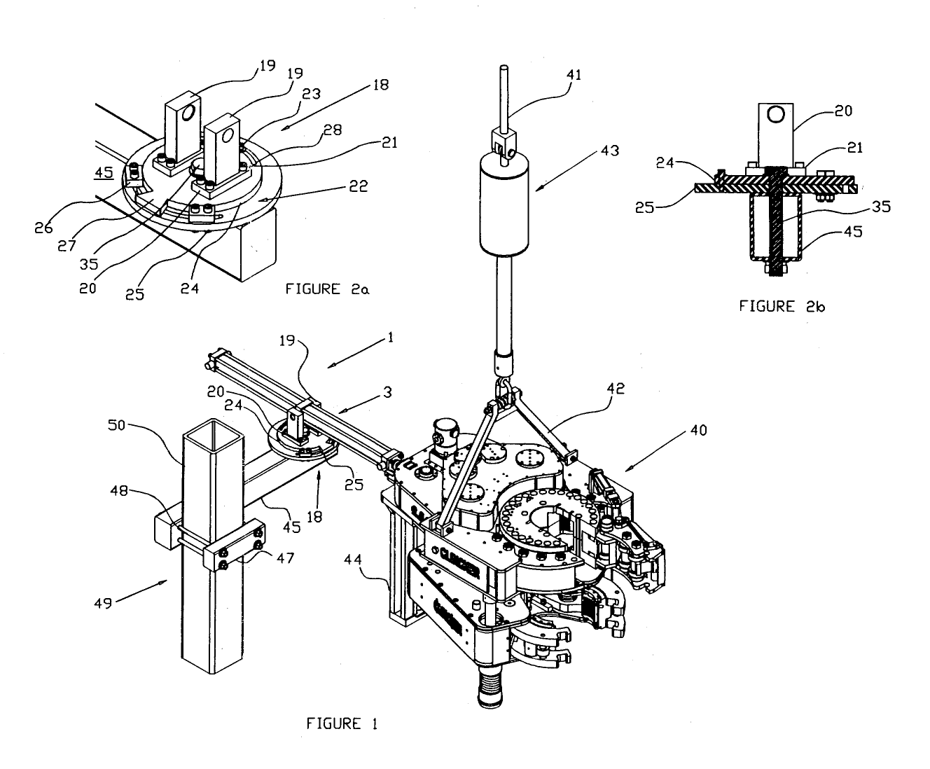

FIG. 1 illustrates the tong positioner 1 connected to a power tong assembly 40. As mentioned above, power tong assembly 40 is suspended by way of cable 41 which will extend from a drilling derrick, crane or other over-head structure. The power tong assembly 40 will be connected to cable 41 through tong bridle 42 and shock-absorbing lift cylinder 43. A conventional tong hanger 44 is connected between the power tong and back-up tong and helps maintain the tongs as a unified assembly. All of the elements just described are well known in the art and do not form pair of the present invention

To the rear of power tong assembly 40 is shown the present invention, tong positioner 1. Tong positioner 1 is designed to be attached to and supported by the structural members of conventional drilling rigs. In the embodiment of FIG. 1, there is shown a vertical rig structural member 50. A support arm 45 will be secured to rig structural member 50 by a conventional means such as bracket assembly 46 which includes a brace member 47 and retaining bolts 48 which serve to clamp support arm 45 to rig structural member 50. Positioned on the opposite end of support arm 45 is base plate 18. As best seen in FIG. 2a, base plate 18 further comprises bottom disc 25 and top disc 24. FIG. 2b illustrates how center bolt 35 will pass through top disc 24, bottom disc 25, and support arm 45. However, bottom disc 25 is fixed to support arm 45 by welding or other convention means and center bolt 35 provides the means for pivotally attaching top disc 24 to bottom disc 25.

Connected to top disc 24 by bolts or other conventional removable connecting means will be mounting feet 20. Trunnion brackets 19 will then be permanently fixed to mounting feet 20 byway of welding or other conventional means. As is well known in the art, trunnion brackets 19 will have apertures for engaging the trunnions on piston and cylinder assembly 3 and thereby pivotally support piston and cylinder assembly 3 as seen in FIG. 1.

Top disc 24 will rotate on and relative to bottom disc 25 to the degree allowed by locking mechanism 22. In the embodiment shown in FIG. 2a, locking mechanism 22 comprises a locking bolt 23 disposed within a channel 28 formed in top disc 24. It will be readily apparent how locking bolt 23 may be loosened and top disc 24 rotated within the limits of channel 28 before locking bolt 23 is then tightened again to lock the relative positions of top disc 24 and bottom disc 25. Another aspect of locking mechanism 22 are limiting blocks 26 and lug 27 formed on top disc 24 opposite of channel 28. Limiting block 26 will be adjustably positioned in a channel 29 formed in bottom plate 25. While hidden from view by trunnion bracket 19, it will be understood that there is a second limiting block 26. Thus, even when locking bolt 23 is not tightened, the constraint of lug 27 between the limiting blocks 26 will limit the rotation of top disc 24 relative to bottom disc 25. Of course, it will be apparent that the degree to which piston and cylinder assembly 3 may rotate on base plate 18 is controlled by the degree to which top disc 24 may rotate.

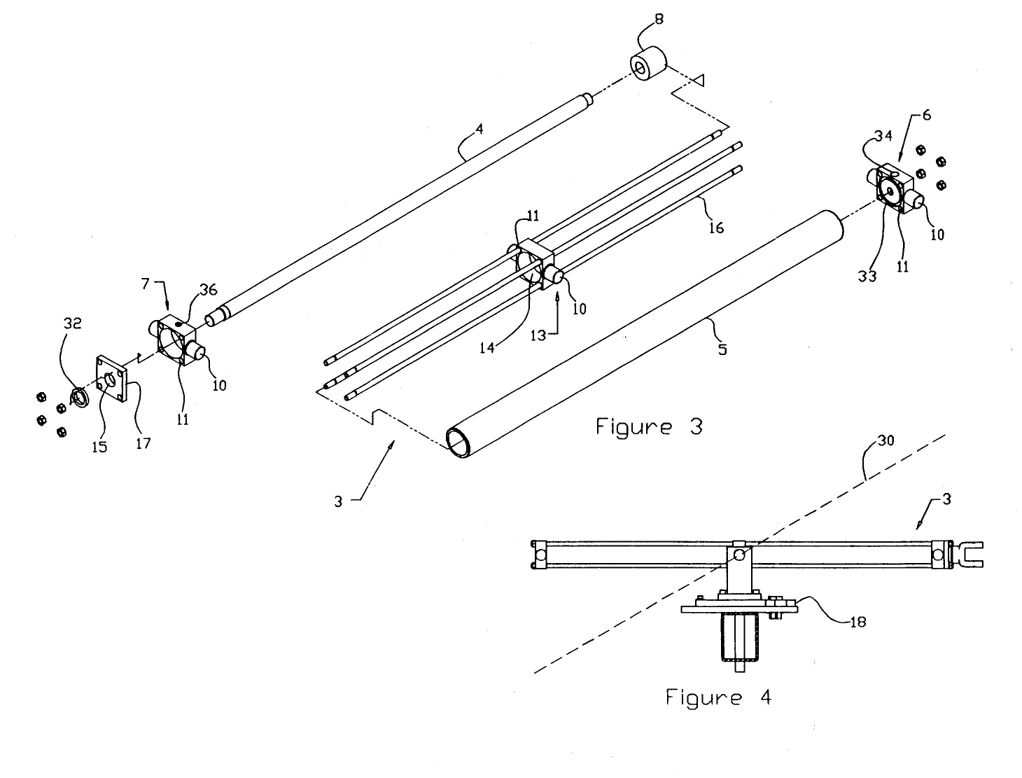

FIG. 3 is an exploded view illustrating the components of piston and cylinder assembly 3. Piston and cylinder assembly 3 will most fundamentally comprise a cylinder 5 with a piston rod 4 having a piston 5 contained therein. While the ends of cylinder 5 could be formed in many different manners, in the embodiment shown, end caps 6 and 7 will be fitted on the end of cylinder 5 to completely enclose the internal space of cylinder 5 and allow the buildup of hydraulic pressure necessary to drive piston rod 4. End caps 6 and 7 also have trunnions 10 extending from the sides thereof and may be referred to as trunnion fitted end caps. Trunnion fitted end caps such as seen in FIG. 3 are available from Lynair, Inc. located in Jackson, Mich. under the designation Front Trunnion Mount Model E and Rear Trunnion Mount Model F. Front end cap 7 will further include a gland seal 32 and gland plate 17 with an appropriate aperture 15 through which piston rod 4 may travel. Front end cap 7 will also include a hydraulic fluid inlet/outlet port 36. Rear end cap 6 will have an o-ring type seal 35 and a hydraulic fluid inlet/outlet port 34 formed therein. Both front and rear end caps 6 and 7 will also have bolt apertures 11. These threaded bolt apertures 11 will be sized to engage threaded tie rods 16. It will be readily apparent how nuts on tie rods 16 may act to tighten end caps 6 and 7 onto cylinder 5 to whatever degree is needed to withstand the internal hydraulic pressures to which cylinder 5 will be subjected. It will be understood that piston and cylinder assembly 3 is a double acting piston and cylinder assembly. Hydraulic fluid is pumped into port 34 to extend the piston rod while fluid exits port 36. To retract the piston rod, hydraulic fluid is pumped into port 36 while it exits port 34.

Also shown in FIG. 3 is intermediate trunnion mount 13. Intermediate trunnion mount is a plate member which will include trunnions 10 and a center aperture 14 which is sized to allow intermediate trunnion mount 13 to slide over cylinder 5. Intermediate trunnion mount 13 also has threaded bolt apertures 11 which allow the mount to be fixed at a given position along the length of cylinder 5. Naturally, a preferred position of intermediate trunnion mount 13 is at approximately the center of cylinder 5.

FIG. 4 illustrates a side view of piston and cylinder assembly 3 and mounting plate 18. It can be seen that the degree to which piston and cylinder assembly 3 may rotate up and down is limited by base plate 18. This distance is represented by dashed line 30 and angle alpha. In the embodiment shown, alpha typically is no greater than approximately 30 degrees. However, there may be operating conditions in which it would be desirable to design embodiments with an alpha of more than 30 degrees and such embodiments should be considered within the scope of the present invention.

Viewing FIG. 1, it can be seen how the piston rod of piston and cylinder assembly 3 will be connected to the tong hanger 44. While not explicitly shown, tong hanger 44 will have a male clevis and piston rod 4 will have a female clevis to effect this connection. Extending and retracting piston rod 4 from cylinder 5 will move tong assembly 40 forwards and backwards. If it is necessary for piston and cylinder assembly 3 to pivot up or down slightly (as suggest by FIG. 4), this is allowed by trunnions 10 rotating within the apertures in trunnion brackets 19. If it is necessary for piston and cylinder assembly 3 to rotate left or right, it is allowed to do so within the limits provided by locking mechanism 22 on base plate 18. Providing these two degrees of freedom (up/down pivoting, left/right rotation) in a tong positioner is a significant and useful improvement in the art. Finally, while the present invention has been described in terms of specific embodiments, those skilled in the art will recognize many obvious modifications and variations. All such modifications and variations are intended to come within the scope of the following claims.

I claim:

1. A tong positioning device comprising:
a. a support arm;
b. a base plate rotatably connected to said support arm;
c. a piston and cylinder assembly having a trunnion attached there to; and
d. a trunnion bracket pivotally securing said piston and cylinder assembly to said base plate.

2. The tong positioning device according to claim 1, wherein said trunnion bracket further comprises a plate with a center aperture sized to accommodate the cylinder of said piston and cylinder assembly and said plate is held in position with a set of tie rods.

3. The tong positioning device according to claim 2, further including trunnion fitted end caps held in position on said piston and cylinder assembly with said set of tie rods.

4. The tong positioning device according to claim 1 wherein said base plate has a locking mechanism to releasably fix the rotated position of piston and cylinder assembly relative to said support arm.

5. The tong positioning device according to claim 1, wherein said trunnion brackets include mounting feet which are connected to said base plate.

6. The tong positioning device according to claim 1, wherein a cylinder of said piston and cylinder assembly has trunnion mounts positioned at each end and at approximately a midpoint along a length of said cylinder.

7. A combination power tong and positioning device comprising:
a. a power tong suspended from an overhead cable;
b. a tong positioner including
i. a support arm;
ii. a base plate rotatably connected to said support arm;
iii. a piston and cylinder assembly having a trunnion attached there to;
iv. a trunnion bracket pivotally securing said piston and cylinder assembly to said base plate;
c. wherein a piston rod of said piston and cylinder assembly is connected to said suspended power tong.

8. A tong positioning device comprising:
a. a support means;
b. a base means rotatably connected to said support means;
c. a piston and cylinder assembly having a pivoting means attached there to; and
d. a means for pivotally securing said piston and cylinder assembly to said base means.
